(19) United States
(12) Patent Application Publication
(10) Pub. No.: US 2008/0039190 A1
(43) Pub. Date: Feb. 14, 2008

(54) PRODUCTS AND PROCESSES FOR CASHLESS GAMING

(76) Inventors: Jay S. Walker, Ridgefield, CT (US); Daniel E. Tedesco, Shelton, CT (US); James A. Jorasch, Westport, CT (US); Geoffrey M. Gelman, Brooklyn, NY (US); Stephen C. Tulley, Monroe, CT (US); Robert C. Tedesco, Fairfield, CT (US)

Correspondence Address: CARSON FINCHAM;Walker Digital Management, LLC, 2 High Ridge Park, Stamford, CT, 06905, US

(21) Appl. No.: 11/456,920

(22) Filed: Jul. 12, 2006

(30) Foreign Application Priority Data
Jan. 20, 2005 (US) PCT/US05/02233

(51) Int. Cl. A63F 13/00; G06F 17/30

(52) U.S. Cl. 463/25; 707/3

(57) ABSTRACT

Products and processes are disclosed for receiving a wager for play of a gaming device. An outcome for play of the gaming device is determined, and a payout amount based on the outcome and the wager is determined. An alternate payout is also determined. A request to cash out is received, and a cashless gaming ticket that represents the alternate payout is output.

This application claims priority from International Application No. PCT/US2005/002233 filed Jan. 20, 2005 which published as WO 2005/070509 on Aug. 4, 2005 and also claims priority from U.S. Provisional Patent Application Ser. No. 60/537,755, filed Jan. 20, 2004, entitled “SYSTEMS AND METHODS FOR IMPROVED CASHLESS GAMING”.

### BRIEF DESCRIPTION OF THE DRAWINGS

FIG. 1 illustrates an embodiment of a system including a controller in communication with a plurality of gaming devices.

FIG. 2 illustrates an embodiment of a controller.

FIG. 3 illustrates an embodiment of a gaming device.

FIG. 4 illustrates an embodiment of a payout database.

FIG. 5 illustrates an embodiment of a probability table.

FIG. 6 illustrates an embodiment of a ticket database.

FIG. 7 illustrates an embodiment of a cashless gaming ticket.

FIG. 8 illustrates an embodiment of a cashless gaming ticket.

FIG. 9 illustrates an embodiment of a cashless gaming ticket.

FIG. 10 illustrates an embodiment of a cashless gaming ticket.

### DETAILED DESCRIPTION

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. Those skilled in the art will recognize that the disclosed invention(s) may be practiced with various modifications and alterations. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Neither the Title (set forth at the beginning of the first page of this patent application) nor the Abstract (set forth at the end of this patent application) is to be taken as limiting in any way as the scope of the disclosed invention(s).

The terms “an embodiment”, “embodiment”, “embodiments”, “the embodiment”, “the embodiments”, “one or more embodiments”, “some embodiments”, “one embodiment” and the like mean “one or more (but not all) embodiments of the disclosed invention(s)”, unless expressly specified otherwise.

The terms “including”, “comprising” and variations thereof mean “including but not limited to”, unless expressly specified otherwise.

The enumerated listing of items (which may or may not be numbered) does not imply that any or all of the items are mutually exclusive, unless expressly specified otherwise. Likewise, the enumerated listing of items (which may or may not be numbered) does not imply that the items are comprehensive of any category, unless expressly specified otherwise.

The terms “a”, “an” and “the” mean “one or more”, unless expressly specified otherwise.

The terms “plurality” mean “two or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention(s).

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

Each process/method includes one or more steps, and therefore a reference to a “step” of a method has an inherent antecedent basis.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media in a number of well-known manners. In some embodiments, hard-wired circuitry or custom hardware may be used in place of, or in combination with, software instructions for implementation of the processes of the present invention. Thus, embodiments are not limited to any specific combination of hardware and software

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed.

### DEFINITIONS

Cashless Gaming Ticket, Ticket: A substrate (e.g., a small piece of paper) that may be output and/or received by a gaming device (e.g., via a “ticket-in/ticket-out” slot of a gaming device or its peripheral). The substrate comprises (i) machine-readable indicia (e.g., a bar code) or other machine-readable substance (e.g., magnetically encoded material). The substrate may also comprise (ii) a ticket identifier (e.g., a unique series of numeric digits or alphanumeric characters). A cashless gaming ticket typically entitles its bearer to an amount of credits or currency equal to an indicated face value. For example, a gaming device player may have a balance of 35 credits. Upon cashing out, the player may be provided with a ticket indicating a face value of 35 credits. The ticket may then be used to (i) establish a balance of 35 credits at a gaming device (e.g., the player inserts a ticket output from a first machine into a second machine), or (ii) receive an equivalent amount of currency (e.g., if each credit is worth one dollar, a cashier provides the player with $35 in cash in exchange for the ticket); or (iii) provide another benefit, as disclosed herein.

Cash Out, Cashout: A process by which a player of a gaming device is provided with payment. Such payment is typically provided by the gaming device, e.g., in the form of coins, tokens or a cashless gaming ticket.

Controller, Central Controller, Slot Server: One or more electronic devices (e.g., a computer, two distinct servers) that communicates with one or more gaming devices. A controller may manage, direct or otherwise affect the actions of gaming devices, such as by providing a random number to a gaming device, by reading data about a player playing a gaming device. A controller may also contain or otherwise be configured to read data from and/or write data to one or more (local or remote) databases regarding, among other things, (i) data associated with a particular cashless gaming ticket or coupon, (ii) player data, (iii) payout data, (iv) probability data, etc.

Credit Balance, Balance: An indication of an amount of currency (or other value) that is due to a player. In some embodiments, a balance may be associated with a gaming device being operated by a player. Such an indication may be output via a gaming device display, such as an LED “credit meter.” In some embodiments, a player wishing to cash out is provided with payment (e.g., a cashless gaming ticket) equal to his credit balance, or otherwise based on his credit balance (e.g., the integer amount of a credit balance, such as $5.00 for a balance of $5.50).

Game: A wagering activity whereby a player posts consideration, usually monetary in form, in exchange for a chance at winning a payout (which is typically a monetary payout). The definition is intended to include basic games and bonus games.

Game Device, Gaming Device, Game Machine, Gaming Machine: Any electrical, electromechanical and/or mechanical device that (in a manner well known in the art) accepts wagers, determines an outcome and pays winnings (if any) based on the outcome. The outcome may be randomly generated (as with a slot machine); may be generated through a combination of randomness and player skill (as with video poker); or may be generated entirely through player skill. Gaming devices may include slot machines (both video and mechanical reel slot machines), video poker machines, video blackjack machines, video roulette machines, video keno machines, video bingo machines, pachinko machines, video lottery terminals, handheld gaming devices, and the like.

Game Play, Play, Spin: A single play of a game at a gaming device that generates a singular, corresponding outcome (e.g., a player pulls the handle of a slot machine and the reels resolve to “Bar-Bar-Bar”). In one embodiment, a player wagers a number of credits in accordance with each game play. In some embodiments, one or more game plays may be associated with a particular cashless gaming ticket. For example, (i) the wagered credits of a game play may be derived from a balance credits generated by an inserted ticket, or (ii) a game play may occur during a session initiated by a ticket.

Game Session, Gaming Session, Session: A gambling event with a beginning and end that may encompass one or more game plays. The end of the session may be determined voluntarily (e.g., in which the player elects to stop play) or involuntarily (e.g., in which the gaming device terminates play). In some embodiments, a game session may be associated with a particular cashless gaming ticket. For example, an associated session may begin when a player inserts a particular cashless gaming ticket, and end when the player cashes out.

Player Tracking Card: Most casinos issue plastic cards (typically resembling frequent shopper cards) to players as a way of identifying the player at a slot machine or table game. As is well known in the art, such cards typically have encoded thereon (in machine-readable and/or human readable form) a player identifier (e.g., a six digit number) which uniquely identifies the player (e.g., because the number is associated with a record in a player database that includes corresponding player information). At a slot machine, the player inserts the card into a corresponding reader device and the player identifier is read (e.g., magnetically or optically ) from the card. From the player identifier which the reader device reads, the corresponding player information may in turn be determined (e.g., read from the database, typically via a network connection between the reader device and a device hosting the database).

### Controller and Gaming Device

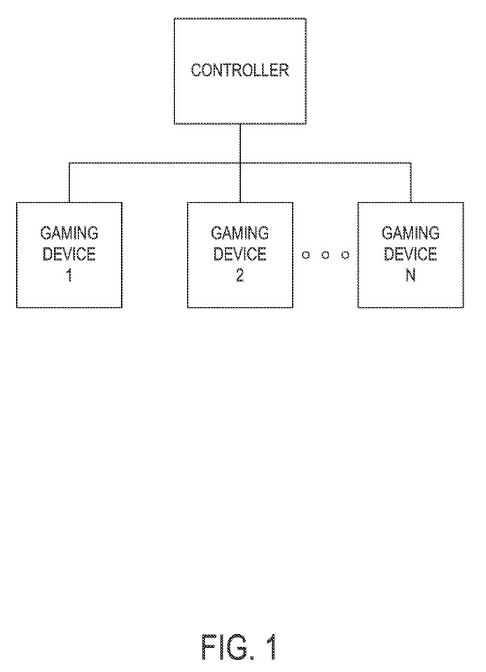

In an embodiment illustrated in FIG. 1, a controller may be in communication with one or more gaming devices in a manner known in the art. Further, in an embodiment the controller may comprise two distinct computers or servers, such as a first server that manages player-related functionality (e.g., managing comp points, identifying players by their player tracking cards) and a second server that manages game-related functionality (e.g., providing random numbers, providing game software, executing instructions for directing game play).

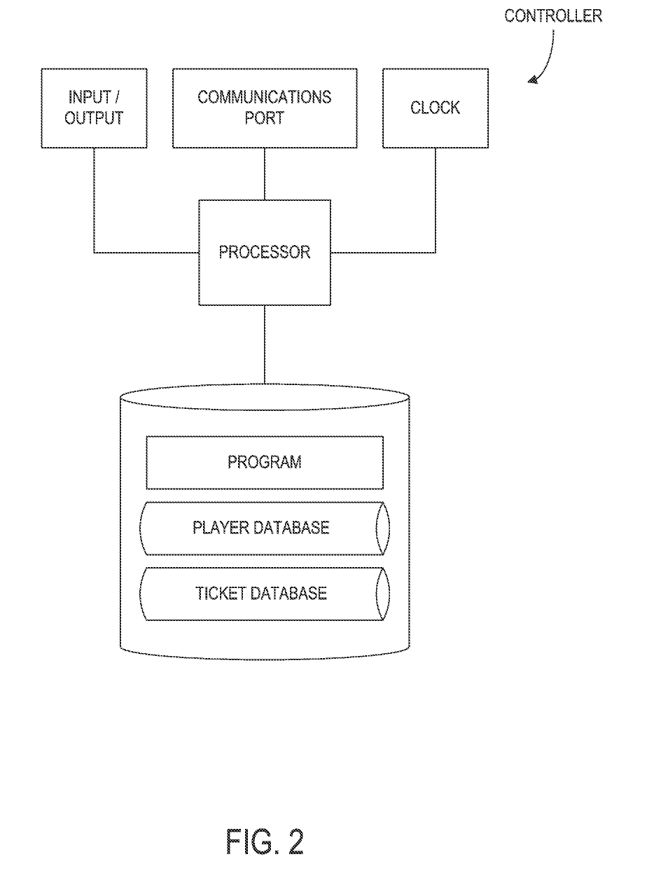

An illustration of a controller according to one embodiment is depicted in FIG. 2. The illustration depicts a processor in communication with a set of known components, such as a clock, communications port, input and output device(s), and a storage device that stores a program and databases.

### Gaming Device

The gaming device may be implemented as a system controller, a dedicated hardware circuit, an appropriately programmed general-purpose computer, or any other equivalent electronic, mechanical or electromechanical device. The gaming device may comprise, for example, a slot machine, a video poker machine, a video blackjack machine, a video keno machine, a video lottery machine, a pachinko machine or a table-top game (e.g., blackjack played at a gaming table with a dealer).

In various embodiments, a gaming device may comprise, for example, a personal computer (e.g., which communicates with an online casino Web site), a telephone (e.g., to communicate with an automated sports book that provides gaming services), or a portable handheld gaming device (e.g., a PDA). The gaming device may comprise any or all of the gaming devices of the aforementioned systems. In some embodiments, a user device such as a PDA or cell phone may be used in place of, or in addition to, some or all of the gaming device components. Further, a gaming device may comprise a personal computer or other device operable to communicate with an online casino and facilitate game play at the online casino. In one or more embodiments, the gaming device may comprise a computing device operable to execute software that simulates play of a reeled slot machine game, video poker game, video blackjack game, video keno game, video roulette game, or lottery game.

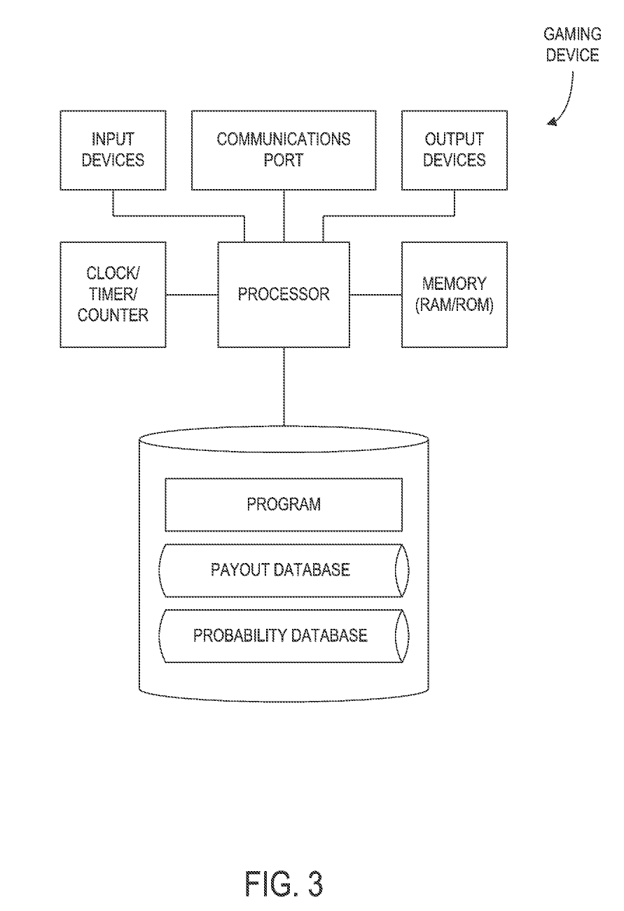

An embodiment of a gaming device is shown in FIG. 3. The gaming device comprises a processor, such as one or more Intel® Pentium® processors. The processor is operable to communicate with a random number generator, which may be a component of the gaming device, the processor itself, or a remote device that is not a component of the gaming device. The random number generator, in accordance with at least one embodiment, may generate data representing random or pseudo-random values (referred to as “random numbers” herein). The random number generator may generate a random number, for example, every predetermined unit of time (e.g., every thousandth of a second) or in response to an initiation of a game on the gaming device. In the former embodiment, the generated random numbers may be used as they are generated (e.g., the random number generated at substantially the time of game initiation is used for that game) and/or stored for future use. A random number generated by the random number generator may be used by the processor to determine, for example, at least one of an outcome and payout.

A random number generator, as used herein, may be embodied as a processor separate from but working in cooperation with the processor. Alternatively, the random number generator may be embodied as an algorithm, program component, or software stored in the memory of the gaming device and used to generate a random number. Note that, although the generation or obtainment of a random number is described herein as involving a random number generator of a gaming device, other methods of determining a random number may be employed. For example, a gaming device owner or operator may obtain sets of random numbers that have been generated by another entity. HotBits™, for example, is a service that provides random numbers that have been generated by timing successive pairs of radioactive decays detected by a Geiger-Muller tube interfaced to a computer. A blower mechanism that uses physical balls with numbers thereon may be used to determine a random number by randomly selecting one of the balls and determining the number thereof.

The processor may also be operable to communicate with an output device, which may be a component of gaming device. The output device may comprise one or more devices for outputting a benefit to a player of the gaming device. For example, in one embodiment the gaming device may provide coins and/or tokens to a player as a benefit. In such an embodiment the output device may comprise a hopper and hopper controller, for dispensing coins and/or tokens into a coin tray of the gaming device.

In some embodiments, the gaming device may provide a substrate (e.g., ticket, coupon, ticket or other document) upon which there is printed an indication of a benefit (e.g., a cashless gaming ticket that has printed thereon a monetary value redeemable for cash or gaming credits; a cashless gaming coupon, which when combined with a cashless gaming ticket, provides the bearer with a benefit such as promotional credits). In such an embodiment, the output device may comprise a substrate printing and dispensing mechanism. An exemplary substrate, manufactured by Slot-Tickets™ of Memphis, Tenn., is a paper ticket measuring approximately 2.5″ by 6″.

In some embodiments, a gaming device may comprise or otherwise communicate with an input/output device. Such a “ticket-in/ticket-out” device may be capable of both printing and receiving cashless gaming tickets. Input/output devices may also be operable to perform various accounting functions (i.e., ticket validation and redemption). For example, both a gaming device and a personal computer maintained at a cashier cage may communicate with a central ticket validation server. One example of such ticket-in/ticket-out technology, the EZ Pay™ system, is manufactured by International Gaming Technology, headquartered in Reno, Nev.

In one embodiment, a ticket database may be stored (e.g., on the controller), and such a ticket database may be employed to track the value(s) of each of a plurality of cashless gaming tickets. For example, according to an embodiment, each ticket is denoted by a unique ticket identifier (e.g., a series of digits). Accordingly, a ticket database may include a plurality of records, each of which represents a cashless gaming ticket and each of which is identified by the corresponding unique ticket identifier.

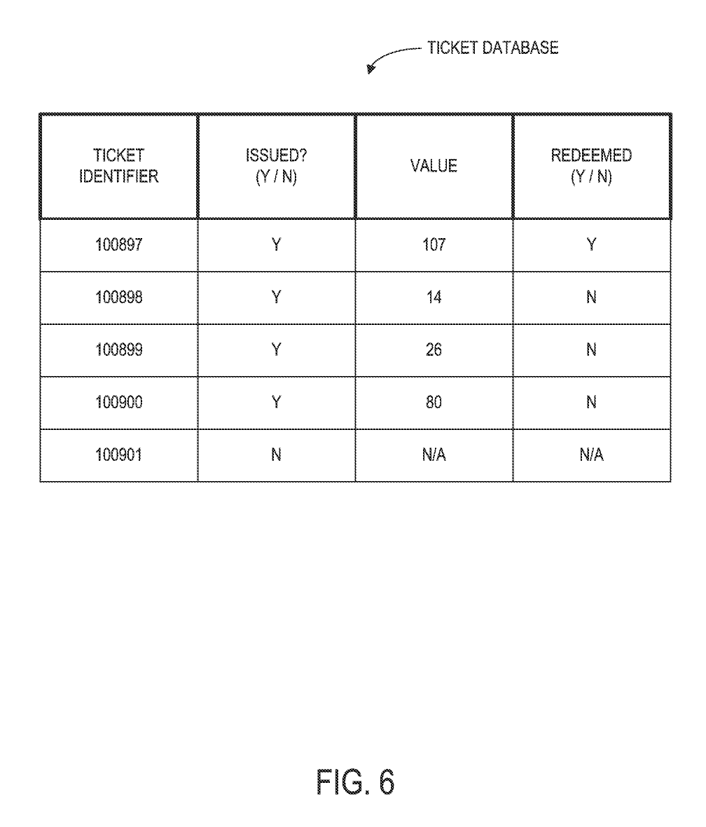

FIG. 6 illustrates an embodiment of a ticket database in which each of a plurality of records indicates (i) a unique ticket identifier, (ii) a value of the ticket, and (iii) whether the ticket has been redeemed. In accordance with various embodiments, each record may indicate a plurality of values of the ticket (e.g., in an embodiment where a ticket may be redeemed for more than one benefit). Each record may also indicate the value for which a ticket was redeemed.

In yet another example, the gaming device may provide electronic credits as a benefit (which, e.g., may be subsequently converted to coins and/or tokens and dispensed from a hopper into a coin tray). In such an embodiment the output device may comprise a credit meter balance and/or a processor that manages the amount of electronic credits that is indicated on a display of a credit meter balance. In yet another example, the gaming device may credit a monetary amount to a financial account associated with a player as a benefit provided to a player. The financial account may be, for example, a credit card account, a debit account, a charge account, a “smart card,” a checking account, or a casino account (e.g., a “player account” accessible via a “player tracking card”). In such an embodiment the output device may comprise a device for communicating with a server on which the financial account is maintained. Note that, in one or more embodiments, the gaming device may include more than one output device. For example, the gaming device may include both a hopper and hopper controller combination and a credit meter balance; or, a hopper and hopper controller combination and a ticket-in/ticket-out device. Such a gaming device may be operable to provide more than one type of benefit to a player of the gaming device. A single output device may be operable to output more than one type of benefit. For example, an output device may be operable to increase the balance of credits in a credit meter and communicate with a remote device in order to increase the balance of a financial account associated with a player.

The processor is also operable to communicate with a display device, which may be a component of gaming device. The display device may comprise, for example, one or more display screens or areas for outputting information related to game play on the gaming device, such as a cathode ray tube (CRT) monitor, liquid crystal display (LCD) screen, or light emitting diode (LED) screen. In one or more embodiments, a gaming device may comprise more than one display device. For example, a gaming device may comprise an LCD display for displaying electronic reels and a display area that displays rotating mechanical reels. In some embodiments, an LCD screen may perform both output and input functions (i.e. via “touch-screen” technology).

The processor may also be in communication with one or more other output devices besides the display device, for outputting information (e.g., to a player or another device). Such other one or more output devices may also be components of a gaming device. Such other one or more output devices may comprise, for example, an audio speaker (e.g., for outputting an outcome or information related thereto, in addition to or in lieu of such information being output via a display device), an infra-red transmitter, a radio transmitter, an electric motor, a printer (e.g., such as for printing cashless gaming tickets and/or coupons), a product dispenser, an infra-red port (e.g., for communicating with a second gaming device or a portable device of a player), a Braille computer monitor, and a coin or bill dispenser. For gaming devices, common output devices include a cathode ray tube (CRT) monitor on a video poker machine, a bell on a gaming device (e.g., rings when a player wins), an LED display of a player's credit balance on a gaming device, an LCD display of a personal digital assistant (PDA) for displaying keno numbers.

The display device may comprise, for example, one or more display areas. For example, one of the display areas (e.g., a primary game screen) may display outcomes of games played on the gaming device (e.g., electronic reels of a gaming device). Another of the display areas (e.g., a secondary game screen) may display rules for playing a game of the gaming device. Yet another of the display areas may display the benefits obtainable by playing a game of the gaming device (e.g., in the form of a payout table). In one or more embodiments, the gaming device may include more than one display device, one or more other output devices, or a combination thereof (e.g., two display devices and two audio speakers).

The processor may also be in communication with one or more input devices(devices that are capable of receiving an input, e.g., from a player or from another device). Such an input device may be a component of gaming device. An input device may communicate with or be part of another device (e.g., a server, a gaming device, etc.). Some examples of input devices include: a bar-code scanner, a magnetic stripe reader, a computer keyboard or keypad, a button, a handle, a keypad, a touch-screen, a microphone, an infrared sensor, a voice recognition module, a coin or bill acceptor, a ticket acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from a second gaming device or from a another device such as a smart card or PDA of a player), and a weight scale. For gaming devices, common input devices include a button or touch screen on a video poker machine, a lever or handle connected to the gaming device, a magnetic stripe reader to read a player tracking card inserted into a gaming device, a touch screen for input of player selections during game play, and a coin and bill acceptor.

The processor may also be in communication with a payment system, which may be a component of the gaming device. The payment system is a device capable of accepting payment from a player (e.g., a bet or initiation of a balance) and/or providing payment to a player (e.g., a payout). Payment is not limited to money, but may also include other types of consideration, including products, services, and alternate currencies. Exemplary methods of accepting payment by the payment system include (i) receiving hard currency (i.e. coins or bills), and accordingly the payment system may comprise a coin or bill acceptor; (ii) receiving an alternate currency (e.g., a paper cashless gaming ticket, a coupon, a non-negotiable token), and accordingly the payment system may comprise a bar code reader or other sensing means; (iii) receiving a payment identifier (e.g., a credit card number, a debit card number, a player tracking card number) and debiting the account identified by the payment identifier; and (iv) determining that a player has performed a value-added activity (e.g., participating in surveys, monitoring remote images for security purposes, referring friends to the casino).

The processor may be in communication with a memory and a communications port (e.g., for communicating with one or more other devices). The memory may comprise an appropriate combination of magnetic, optical and/or semiconductor memory, and may include, for example, Random Access Memory (RAM), Read-Only Memory (ROM), a compact disc and/or a hard disk. The memory may comprise or include any type of computer-readable medium. The processor and the memory may each be, for example: (i) located entirely within a single computer or other device; or (ii) connected to each other by a remote communication medium, such as a serial port cable, telephone line or radio frequency transceiver. In one embodiment, the gaming device may comprise one or more devices that are connected to a remote server computer for maintaining databases. The memory stores a program for controlling the processor.

The memory may store one or more databases including, for example, a probability database, a payout database, and/or a player database. Some or all of the data stored in each database is described herein by way of one or more example(s). The described entries of the databases represent exemplary information only; those skilled in the art will understand that the number and content of the entries can be different from those illustrated herein. Further, despite any description of the databases as tables, an object-based model could be used to store and manipulate the data types of the present invention and likewise, object methods or behaviors can be used to implement the processes of the present invention.

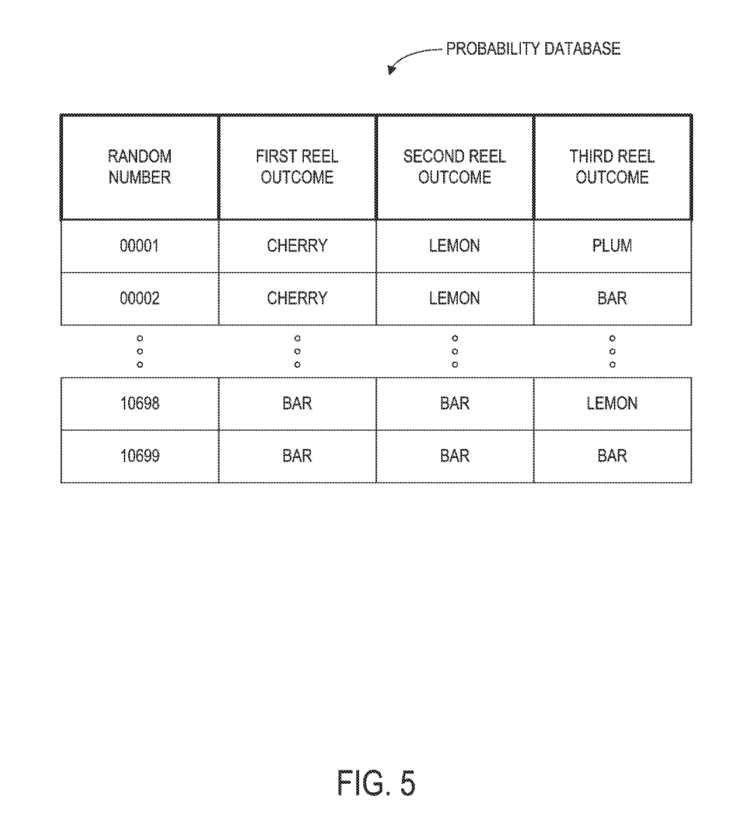

FIG. 5 illustrates a probability database according to an embodiment, in which each of a plurality of possible random numbers (or other randomly generated output) corresponds to an outcome (defined by three reel outcomes in the embodiment depicted in FIG. 5). Where appropriate, a prior art probability database may be utilized (modified or unmodified) in the performance of the processes described herein. A probability database may be stored in the data storage device in tabular form, or any other appropriate database form, as is well known in the art. The data stored therein may include a number of exemplary records or entries, each defining a random number. Those skilled in the art will understand that the probability database may include any number of entries. The tabular representation may also define fields for each of the entries or records. The fields may specify: (i) a random number (or range of random numbers) that may be generated by the random number generator; and (ii) an outcome that indicates the one or more indicia comprising the outcome that corresponds to the random number of a particular record. A gaming device may utilize a probability database to determine, for example, what outcome corresponds to a random number generated by a random number generator and to display the determined outcome. In one embodiment, the outcomes may comprise the three symbols to be displayed along the payline of a three-reel slot machine. Other arrangements of probability databases are possible. For example, the book “Winning At Slot Machines” by Jim Regan (Carol Publishing Group Edition, 1997) illustrates examples of payout and probability tables and how they may be derived. The entirety of this book is incorporated by reference herein.

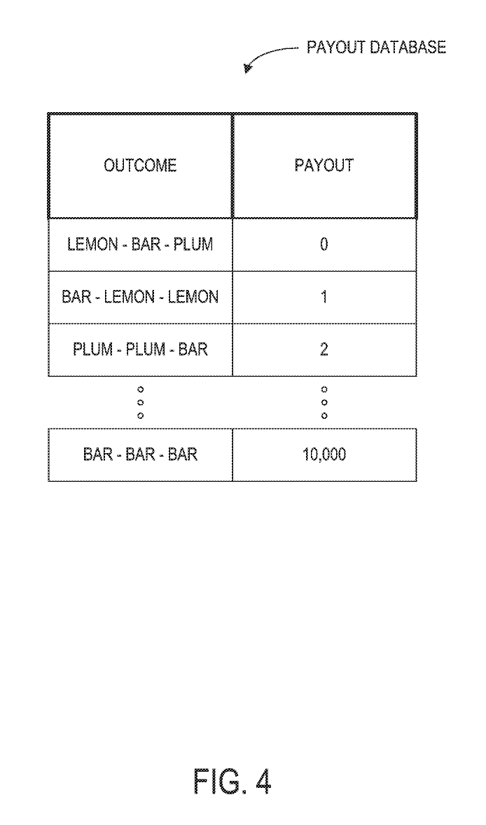

FIG. 4 illustrates a payout database according to an embodiment, in which each of a plurality of possible outcomes corresponds to a payout. Where appropriate, a prior art payout database may be utilized (modified or unmodified) in the performance of the processes described herein. A payout database may be stored in the data storage device in tabular form, or any other appropriate database form, as is well known in the art. The data stored therein includes a number of example records or entries, each defining an outcome that may be obtained on a gaming device that corresponds to a payout. Those skilled in the art will understand that the payout database may include any number of entries. The tabular representation also defines fields for each of the entries or records. The fields specify: (i) an outcome, which indicates the one or more indicia comprising a given outcome; and (ii) a payout that corresponds to each respective outcome. In one embodiment, the outcomes are those obtained on a three-reel slot machine.

A gaming device may utilize the payout database to determine whether a payout should be output to a player as a result of an outcome obtained for a game. For example, after determining the outcome to output on the gaming device, the gaming device may access the payout database to determine whether the outcome for output is one of the outcomes stored as corresponding to a payout. If it is, the gaming device may provide the corresponding payout to the player.

Other arrangements of payout databases are possible. For example, the book “Winning At Slot Machines” by Jim Regan (Carol Publishing Group Edition, 1997) illustrates many examples of payout and probability tables and how they may be derived.

Additionally, where appropriate, a player database may be utilized to store historical data associated with specific players. A player database may be used, for example, to store player wager data so that players wagering over a given threshold in a given amount of time may be rewarded for their patronage. The player database may also contain other information that may be useful in, for example, promoting and managing player behaviors (e.g., information about the player's outstanding debts, previous gaming activity, lodging arrangements, and the like). Further, the player database may store data regarding a given player's standing in a game session or bonus game, so that the player can continue the game session or bonus game at a plurality of game machines that have common access to the player database. Such player data may be stored in a relational database and retrieved or otherwise accessed by the processor after receiving a “key” data point from the player, such as a unique identifier read from the player's player tracking card.

Note that, although these databases may be described as being stored in a gaming device, in other embodiments some or all of these databases (or copies thereof) may be partially or wholly stored in another device, such as one or more of the peripheral devices, the peripheral device server and/or the server computer. Further, some or all of the data described as being stored in the databases may be partially or wholly stored (in addition to or in lieu of being stored in the memory of the gaming device) in a memory of one or more other devices, such as one or more of the peripheral devices, another gaming device, the peripheral device server and/or the computer.

### Slot Machine

As discussed herein, in one or more embodiments the game device may take the form of a slot machine configured to operate in conjunction with the present invention. A description of a slot machine suitable for use with the disclosed invention(s) follows.

A slot machine for use in the present invention may comprise, for example, a three-reel or five-reel slot machine. The slot machine comprises a display area in which an outcome for a game of the slot machine is displayed to the player. The display area may, for example, be a video display that displays graphical representations of reels. The display area may, in another example, be glass behind which are located mechanical reels. Within the display area is a payline. In accordance with one or more embodiments of the present invention, an outcome of a game is a set of symbols displayed along a payline of a reeled slot machine. The slot machine may further comprise a handle. A player may initiate the movement of the reels in the display area by pulling on the handle. Alternatively, a player may initiate the movement of the reels in the display area by actuating a start button. Either or both of the handle and start button are exemplary embodiments of the input device, described herein.

Where appropriate, the slot machine may also include an alternate, secondary game screen, for outputting information to a player. The secondary game screen may be utilized, for example, to inform a player of the player's standing in a game. The slot machine may be capable of altering display and audio content as described herein (e.g., superimposing graphics over digital displays; a mask layer between physical reels and a player that shades or otherwise alters their appearance).

The slot machine may also include a payment system, which may comprise a bill acceptor, a credit card reader, a ticket-in/ticket-out device and/or a coin acceptor. A player may utilize payment system to provide a wager for playing a game and/or for providing payment for provision of an outcome.

The slot machine may further comprise a credit meter balance, which is an exemplary embodiment of an output device described herein. The credit meter balance reflects the amount of electronic credits currently available to a player. The electronic credits may be used by a player, for example, as wagers for games played on the gaming device. The electronic credits may also be “cashed out” as coins, bills, tokens, a cashless gaming ticket, and/or credits to another financial account associated with the player.

Finally, the slot machine may comprise a coin tray. Payment to the player may be rendered by dispensing coins into the coin tray. Such coins may be dispensed based on, for example, a player's indication that the player would like to cash out his credit meter balance and/or a payout obtained by a player as a result of playing a game on the slot machine. The coin tray is an exemplary embodiment of the output device, described herein. Note that, where appropriate, the slot machine may include different and/or additional components besides those discussed in this section.

### Processes

Unless expressly specified otherwise, the processes described herein may be performed by (i) a gaming device, (ii) a controller in communication with a gaming device, (iii) devices operatively connected to gaming devices and/or to controllers (e.g., input and/or output devices), and/or (iv) any combination thereof. Thus, although the following description discusses the steps as performed by a gaming device, it is contemplated that the steps may be performed by any combination of the devices described herein.

### A. Cashless Gaming Tickets with Alternate Values

According to an embodiment, a gaming device may (directly or indirectly) provide players with cashless gaming tickets that are redeemable for an alternate payout, rather than for merely the credit balance in effect when a cash out is requested or directed.

Generally, according to an embodiment, a gaming device receives a wager for play of a gaming device, determines an outcome for play of the gaming device, and determines a payout amount based on the outcome and the wager, all in a known manner. The credit balance is adjusted by the payout amount.

The gaming device also determines an alternate payout, as described in detail herein. After receiving a request to cash out (e.g., from a player by the player pressing a “cash out” button), the gaming device outputs a cashless gaming ticket that represents the one or more alternate payouts (rather than the player's credit balance).

The alternate payout may be in any of a number of forms or combination of forms. In various embodiments, the alternate payout may comprise cash, typically in addition to something else. For example, the alternate payout may comprise cash in an amount equal to half of the credit balance, and in addition to something else.

For example, the alternate payout may comprise a number of “comp points”. Comp points are well known in the art and are typically redeemable at casino for a variety of goods and services.

The alternate payout may comprise a number of credits which may be wagered in gaming at a gaming device, at a table game, etc., thereby encouraging repeated play. In one embodiment, the number of credits in such an alternate payout may be restricted to use at only certain types or categories of gaming devices or games. For example, the number of credits may be wagered only at gaming devices made by a particular manufacturer, only in particular games (e.g., video poker), or only at gaming devices which are branded a particular way (e.g., Monopoly®-branded gaming devices). Further, the designation of which categories of games/gaming devices the number of credits may be wagered at be variable (e.g., any gaming device bearing a red sign, any gaming device having a siren light which is illuminated).

The alternate payout may comprise an amount of credit towards a bill or account of the casino or of another party, such as credit applicable only to a hotel bill, restaurant bill, or merchandise account at an (online or offline) retail store. Such an embodiment is particularly advantageous when the amount of credit (i) is greater than the initial cashless ticket value (typically the credit balance), and/or (ii) is redeemable towards a product having significant “margin” (difference between cost to the seller and price sold for by the seller). Thus, for example, where the credit balance is $45, the alternate payout may be $50 credit towards a particular hotel bill in lieu of receiving $45. If the player were going to purchase, or had already purchased, the particular hotel room, then the $50 credit would typically be more appealing to the player. Simultaneously, the prospect of providing a $50 discount to a player who was owed only $45 may be acceptable to a casino, especially if (i) the casino owned or operated the hotel, (ii) the hotel was reimbursed wholly or partially by the casino for the $50 discount, and/or (iii) the hotel was generally more inclined to sell rooms than it otherwise would be (e.g., the hotel was largely under-booked and had excess capacity).

In an embodiment where the alternate payout comprises an amount of credit towards a bill or account, the amount of alternate credit may be subject to a ceiling (e.g., $50 towards a hotel room, not to exceed 80% of the hotel room's retail price). The amount of alternate credit may be subject to usage restrictions (e.g., $5 off a restaurant bill, only for meals between 2:00 PM and 4 PM weekdays). Such usage restrictions may serve to increase revenues during certain times which would otherwise (or typically) have generated lower revenue.

Accordingly, it can be advantageous if the terms of alternate payout, and/or restriction on their usage, are generated by or with a revenue management system and/or a hotel or airline reservation system, which manage prices towards particular goals (e.g., maximum profitability per time period). In particular, hotels, airlines, etc. can employ such alternate payouts to sell distressed (under-selling) goods/services, especially those which are perishable (cannot be sold well or at all as time passes), at a substantial discount without undermining their fare structures. For example, if certain players (e.g. players who have won more than a threshold amount of money, randomly selected players) are provided with alternate payouts, players will not be capable of accurately predicting discounts in prices of corresponding products.

Likewise, the terms of alternate payout, and/or restriction on their usage, may be received by a third party (e.g., a server operating on behalf of a third-party merchant). In such an embodiment, alternate payouts may be requested and/or received (in substantially real time) from one or more remote devices, such as computers operated by or on behalf of a third party.

The alternate payout may comprise a magazine subscription. In such an embodiment, the ticket may comprise a registration form for the subscription (e.g., the ticket may include or be automatically filled in with fields for the player's name and address). The ticket may have a postage-prepaid field on the reverse side allowing it to be easily mailed to the publisher or subscription fulfillment agent.

The alternate payout may comprise a stored value (“prepaid”) card (e.g., slot card, phone card, gift card redeemable at a retail store). Such prepaid cards may expire, or have a balance which declines with time.

The alternate payout may comprise a chance to receive something. For example, the player may elect to receive a lottery ticket, such as a scratch-off lottery card. The scratch off lottery card may accompany, or be a part of, the cashless gaming ticket. In an embodiment where the cashless gaming ticket is part of the lottery ticket, the cash out value (e.g. the initial cashless ticket value) may be printed above an opaque, removable (e.g., scratch off) portion, so that if the player chooses the lottery ticket, the player is deemed to have forfeited the cash out value. In another embodiment, the ticket may provide an entitlement to enter a drawing (e.g., “Lotto” or “Powerball”). Ideally, once the drawing begins then the ticket may no longer be redeemed for the initial cash out amount. In one embodiment, the number of lottery entries (or the wager value of those entries) could be based on the “face value” of the ticket (the cash out amount).

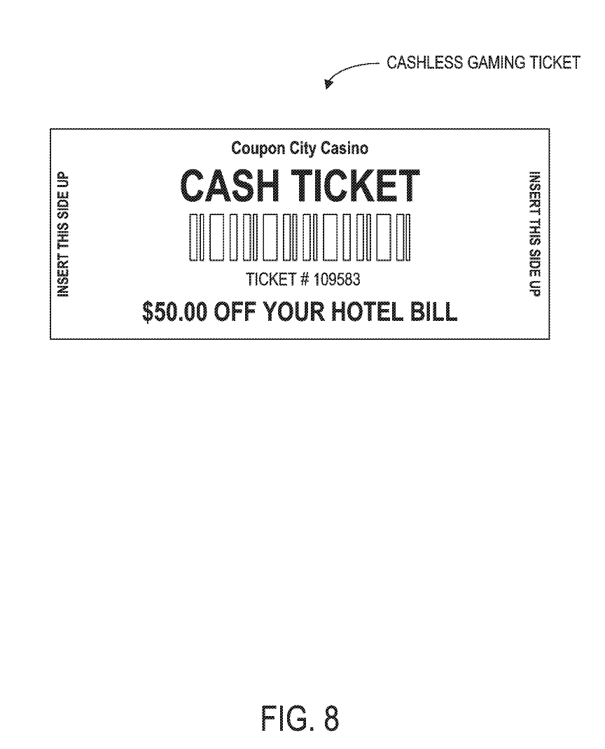

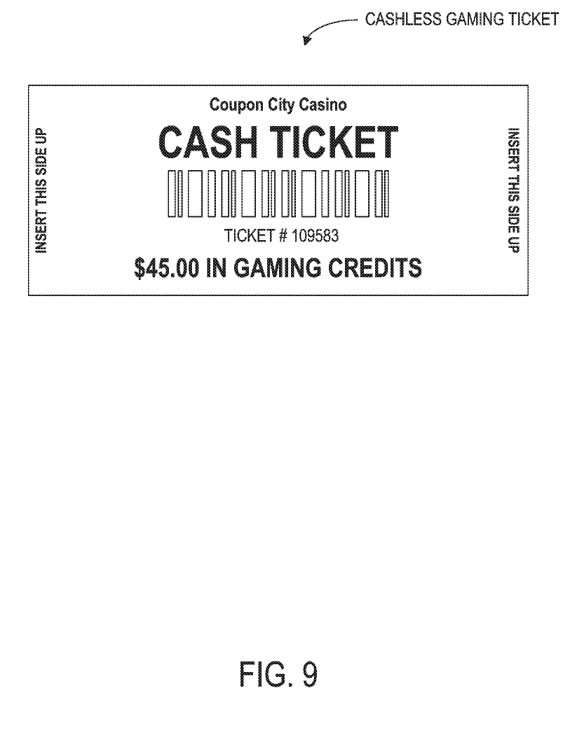

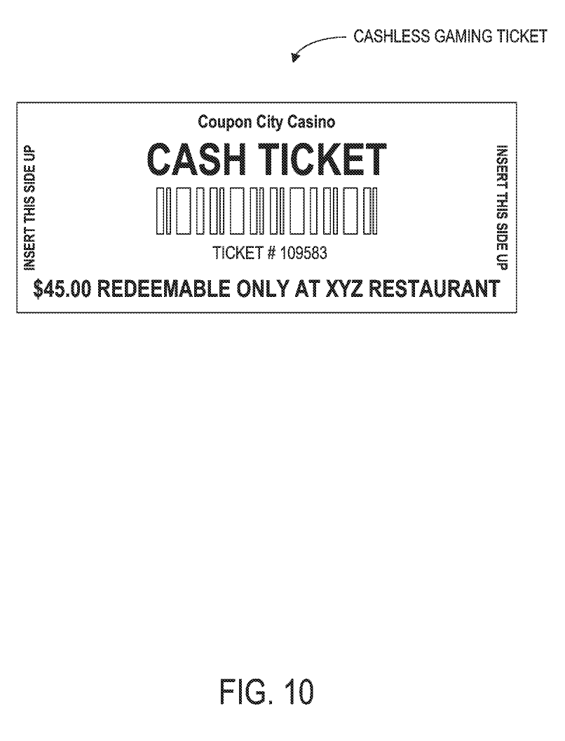

In a first embodiment of a cashless gaming ticket with an alternate value, before the ticket is output, the player may be offered (e.g., via a screen of the gaming device) the choice of receiving (i) his credit balance, and (ii) an alternate payout (or a selected one of several offered alternate payouts) in lieu of his credit balance. The player's choice would then determine the redemption value of the cashless gaming ticket subsequently output by the gaming device (e.g., via a ticket in/ticket out device). Such an offer may (but need not) be triggered by the player choosing to cash out (e.g., by pressing a “cash out” button). Such an offer may alternatively or additionally be presented to a player at other times, such as when the player begins a gaming session, or when the player registers for a player tracking card or similar account. FIG. 8 illustrates a ticket which bears indicia indicating that the ticket may be redeemed for $50 credit towards a hotel bill, and this value may represent a player's previous choice of receiving the $50 credit or receiving one or more other values (e.g., less than $50 in cash). Similarly, FIG. 9 illustrates a ticket which bears indicia indicating that the ticket may be redeemed for $45 credit towards gaming activities, and FIG. 10 illustrates a ticket which bears indicia indicating that the ticket may be redeemed for $45 credit towards a purchase at a particular restaurant.

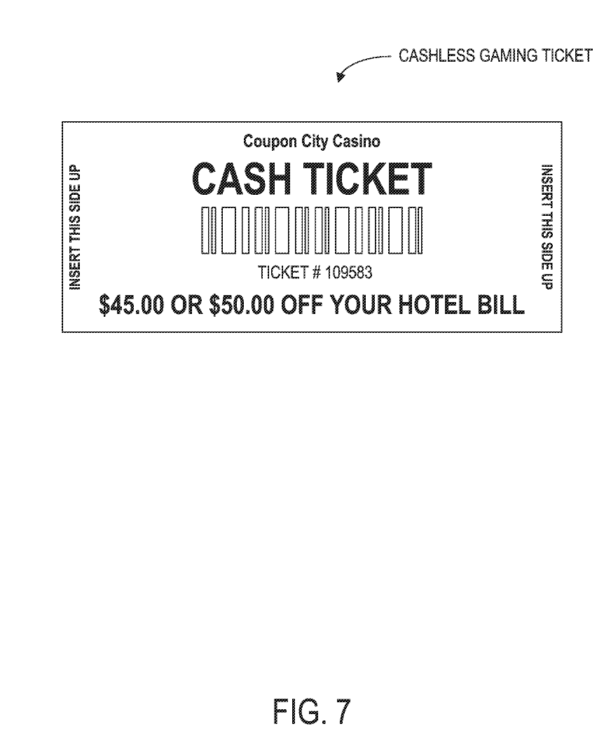

In a second embodiment of a cashless gaming ticket with an alternate value, the cashless gaming ticket may itself be redeemed for one of a plurality of values. This second embodiment need not be mutually exclusive with the first embodiment described immediately above. For example, a particular cashless gaming ticket may, at the player's option, be redeemed for one of (i) the player's credit balance, and (ii) an alternate payout (or a selected one of several offered alternate payouts). Thus, the player need not (but may) choose which option is more desirable until such time as he redeems the ticket. In such an embodiment, the ticket may bear indicia indicating the values for which the ticket may be redeemed. FIG. 7 illustrates a ticket which bears indicia indicating that the ticket may be redeemed for (i) $45, or (ii) $50 credit towards a hotel bill.

In an embodiment in which the player is offered the choice of receiving his credit balance or an alternate payout (in the form of a cashless gaming ticket), such an offer may be output in many known manners, such as output via a graphical user interface on a (touch) screen of the gaming device. The player may then respond to the offer by choosing (e.g., with a key press) one of the options presented in the offer.

In an embodiment in which the player is offered a plurality of alternate payouts, the number and types of different alternate payouts offered may be established based on any of various criteria. For example, the number of different alternate payouts offered may be based on the player's (i) average wager per outcome generated, (ii) maximum wager per outcome generated, (iii) coin in, (iv) credit balance, and/or (v) number of pay lines selected.

In addition, such an offer is typically output before the gaming device outputs a cashless gaming ticket, and may be output even before the player has requested to cash out (e.g., at the beginning of a gaming session).

In one embodiment all players of a gaming device are provided with an offer to receive either the credit balance or an alternate payout. In another embodiment, offers are selectively output, and accordingly the gaming device determines (e.g., upon receiving a request to cash out) whether to output the offer.

For example, the gaming device may determine whether to output the offer based on at least one of (i) at least one prior outcome (e.g., whether the player received a cherry-cherry-cherry outcome on a slot machine); (ii) a number of plays or outcomes generated; (iii) an amount of coin in; (iv) one or more wager amounts (e.g., whether the player is wagering significant amounts); (v) a credit balance (e.g., whether the balance exceeds $500); (vi) a rate of play (e.g., whether the player has played at a rate of more than 100 hands of video poker per hour); (vii) an amount of losses (e.g., whether the player has wagered and lost more than $100 since the start of the gaming session); (viii) a number losing outcomes (e.g., whether more than half of the previous 50 outcomes were losing outcomes, whether there have been more than ten consecutive losing outcomes); (ix) a number pay lines selected (e.g., more than three pay lines selected), and (x) a time of a previous offer (e.g., whether there has been no offer in the last fifteen minutes of game play).

The alternate payout may have a value that is based on the credit balance. For example, the alternate payout may be based on a multiple of the credit balance (e.g., an amount of points that may be redeemed at a casino restaurant, where the amount is valued at 110% of the credit balance). Alternatively, the alternate payout may be based on a sum of the credit balance and a second amount (e.g., an amount of points that may be redeemed at a particular hotel chain, where the amount is valued at the credit balance +$60).

In an embodiment, the alternate payout may have a value that is based on a time since an event, such as the time since (i) the start of a gaming session, (ii) a set of consecutive losing outcomes (e.g., seven losing outcomes in a row), (iii) a time of day, such as 2 PM. It can be advantageous if the value of the alternate payout generally increases over time, since that would generally encourage continued play.

More specifically, the value of the alternate payout can be based on a monotonically non-decreasing function of the time since the event. If the monotonically non-decreasing function is also not a constant with respect to the time since the event (i.e. if the value changes over time), then the function would render values of the alternate payout which (i) do not decrease with time, and also which (ii) increase over at least one predetermined period of time. In other words, during certain periods of time the value might not change, but when it does eventually change it can only increase. For example, the value of the alternate payout may increase by $1 every hour of play since the start of the session.

In such an embodiment where the alternate payout has a value that is based on a time since an event, it can be advantageous to display to the player, or otherwise inform the player, of the value and/or changes in the value. For example, a video display of the gaming device may display the current balance (e.g., $5) and values of alternate payouts (e.g., $7.80 redeemable towards food at participating casino restaurants, $15 redeemable toward casino property entertainment events such as shows and concerts).

When the player requests a cash out, the gaming device may output a confirmation prompt, such as “Are you sure you want to cash out?”. It can be particularly beneficial to also indicate to the player an advantage to delaying cash out, such as with a message “Are you sure you want to cash out? Only ten more spins and you get double food points.” Such confirmation may delay the cash out and/or encourage longer play by the player.

In an analogous manner, the value of a cashless gaming ticket can increase over time, thereby encouraging players to delay redeeming their tickets. For example, a ticket may be redeemable immediately (e.g., for $16) or for more (e.g., for $17) if redeemed in one month. Moreover, the increase in value may continue (e.g., increase in value by $1, or by 0.5% each month). Such tickets may indicate not only their value, but may also indicate the basis from which increases in value are calculated. For example, the ticket could indicate the starting date for calculating increases in value.

Receiving or redeeming a ticket for an alternate payout may be contingent on the player performing one or more specified activities, such as participating in a survey, or participating in a focus group.

In one embodiment, the player may receive the value of an alternate payout provided he persuades a friend to buy a product, perform a task, or the like. For example, the player may be required to persuade a customer to sign up for a player tracking card. In such embodiments, the printed cashless ticket may be accompanied by a player tracking card sign-up form that the player can provide to his friend. The sign-up card can have a code printed thereon that identifies the cashless gaming ticket. Thus, when the card is turned in by the player's friend, the code can be recognized and then the alternate payout may be activated for the player.

Similarly, a player can give a cashless gaming ticket (or other indicator) to a friend, who may in turn redeem the ticket for its face value (e.g., $50). This redemption by the friend can provide an alternate payout to the player (e.g., the value of the player's cashless gaming ticket is increased). This added cost to the casino (of providing extra value to the player and value to the friend) may be an acceptable cost of acquiring a new customer (the friend). In such embodiments, cashless gaming tickets could have (i) postage prepaid indicia on the reverse side, and/or (ii) a blank address field for the gift recipient's address. Cashless gaming tickets may be provided in two parts (1) the player's ticket and (2) a gift portion to be given to a friend. Both portions may have a common code, associated codes, or other ways to link the two portions (e.g., in a database) enabling the player to be credited upon redemption by the friend.

In one embodiment, cashless gaming tickets can expire (and thus be forfeited) if not redeemed by an expiration date (preferably printed on the ticket). This can encourage a return visit to a casino, hotel, etc. in order to redeem the ticket before it expires.

Similarly, the provision or receipt of alternate payouts may be restricted according to various criteria, such as those defined by stored rules. For example, cash out rules may provide that provision of alternate offers (or even just cashing out) may be permitted only (i) a limited number of times per predetermined time period, (ii) a limited number of times per predetermined amount won, (iii) a limited number of times per predetermined amount wagered, and/or (iv) a limited number of times per only gaming session. Such restrictions can promote longer play, or play with desired attributes (e.g., play with high wager amounts).

### B Player Interaction

In the embodiments described herein, the player may interact with the gaming device (or another system) via one or more user interfaces (such as a graphical user interface) that are operable to receive at least one command from a player of the gaming device. For example, such a user interface may be provided before a cashless gaming ticket is output, and the alternate payout for a cashless gaming ticket can be based on one or more commands received via the user interface. Graphical user interfaces, including graphical buttons provided via touch screens, menus, etc., are well known in the art.

Such a user interface can allow a player to direct or modify attributes of a cashless gaming ticket. For example, in an embodiment in which the alternate payout includes payment towards a bill (e.g., a hotel bill), the player may employ the user interface to apply the payment towards the bill, and the gaming device would then direct a computing device responsible for the bill payment to credit the bill in the specified amount. In such an embodiment, the cashless gaming ticket need not be redeemable for anything, but could merely be a receipt that evidences payment. Reconciliation of accounts may subsequently be applied (e.g., the casino might have to render the specified amount, or a portion thereof, to another entity).

A user interface may also be structured to allow a player to enter a code, such as the player's name, a PIN (personal identification number), password, thumbprint, retinal scan or the like, at a certain time (e.g., when the player requests to cash out, or requests a ticket). Such a PIN, etc. could be registered with any cashless gaming ticket subsequently provided to the player. For example, the PIN may be recorded in a database record corresponding to the unique identifier that is printed on the cashless gaming ticket. Thus, redemption of the ticket might require subsequent entry of the registered PIN, etc., or verification of the player's name, in order to verify the identity of the player.

Similarly, gaming machines may include or be connected to a camera or other image capture device. Ideally, the image capture device is positioned to capture images that are proximal to the gaming device (e.g., an image of a player playing the gaming device). The gaming device may thus record an image of the player. The recorded image may be printed on the cashless gaming ticket and/or recorded in a database record corresponding to the cashless gaming ticket. In embodiments where the cashless gaming ticket includes a printed image of the player, casino personnel (e.g. at the casino cage or coin booth) would be able to visually confirm the identity of player before accepting the ticket.

A user interface may also be structured to allow a player to select lottery numbers through the gaming device, and the lottery numbers can be printed on the cashless gaming ticket as a form of alternate payout, or in addition to other (conventional) payout. The ticket thus can serve as a lottery ticket, and can entitle the bearer to winnings in a known manner.

A user interface may also be structured to allow a player to alter the value of a cashless gaming ticket. For example, the user interface may allow the player to select an option to add money to increase the value of the ticket. The player may add money by adding cash through the machine's bill validator or coin acceptor, swiping a credit card in a card reader, and the like. The user interface may allow a player to indicate when he has finished adding money and would like a cashless gaming receipt printed.

In one embodiment, a user interface may be structured to allow a player to generate a gaming ticket which represents only a portion of the player's credit balance (leaving the remainder of the credit balance available for play). For example, a player may choose to “round down” his credit balance to an even bill denomination, and generate a gaming ticket which represents the difference (e.g., to tip a waitress with).

### C. Cashless Gaming Ticket Structure

In accordance with the disclosed embodiments, cashless gaming tickets may bear indicia representing various information and providing various functionality. Further, any such information can be associated with the ticket in a ticket database, allowing the information to be determined, e.g., by the casino. Any such information may additionally or alternatively be encoded, allowing it to be determined only, e.g., by the casino.

For example, the ticket may represent information generated or stored during the player's gaming session (e.g., outcomes generated). Similarly, tickets may represent information such as an amount won by the player, an amount lost by the player, wager amounts of the player, starting balance, ending balance, difference between starting and ending balances, number of outcomes, time played, time that play started, time that play stopped, the name of the game played, and the like. Such information may be desirable, e.g., for the player's tax purposes, to encourage the player.

In an embodiment, a ticket may include (blank or alterable) fields that are to be completed by a player. Such fields may promote the entry and acquisition of desirable information, such as player names, addresses, etc.

Tickets may also represent a balance of “equity” points earned by the player that count toward a “meta game” or bonus game. For example, the player may have received 20 lemon symbols throughout the course of a gaming session. The lemon symbols may be provided on the ticket, so that the player can continue collecting the symbols as he tries to qualify for a special prize, collectible by redeeming the ticket.

A similar manner of play includes providing collectable game pieces (e.g., bingo pieces, U.S. states, cards in a deck) with the ticket or on the ticket, thereby encouraging players to retain cashless gaming tickets rather than immediately cashing them in. Collecting a set of certain game pieces can yield a prize to the player. In an embodiment, different game pieces or types of game pieces may be obtainable from different gamming devices or different games, thereby encouraging trial of, e.g., new gaming devices, new games.

In accordance with the disclosed embodiments, cashless gaming tickets include structure that permits various information to be conveyed, and/or permits various functionality to be realized.

For example, a cashless gaming ticket may be alterable (e.g., physically alterable). Such a ticket may include circles, ovals or check boxes which, when filled in, checked or otherwise registered (e.g., with a number 2 pencil) create machine-readable indicia.

Such a ticket may include perforated portions allowing the ticket to be separated easily into different pieces. The ticket may include an area which is altered by applying a sticker thereto, or by removing a sticker or scratch off material therefrom.

We claim:

1. A method comprising:
receiving a wager for play of a gaming device;
determining an outcome for play of the gaming device;
determining a payout amount based on the outcome and the wager;
adjusting a credit balance by the payout amount;
determining an alternate payout;
receiving a request to cash out; and
outputting a cashless gaming ticket that represents the alternate payout.

2. The method of claim 1, further comprising:
outputting an offer before performing the step of outputting a cashless gaming ticket, in which the offer defines a choice between
receiving an amount based on the credit balance, and
receiving the alternate payout; and
receiving a response to the offer, in which the response defines a selected one of
receiving the amount based on the credit balance, and
receiving the alternate payout.

3. The method of claim 1, further comprising:
outputting an offer before performing the step of outputting a cashless gaming ticket, in which the offer defines a choice of receiving one of a plurality of alternate payouts; and
receiving a response to the offer, in which the response defines a selected one of the plurality of alternate payouts.

4. The method of claim 1, further comprising:
determining whether to output the offer.

5. The method of claim 4, in which determining whether to output the offer comprises:
determining whether to output the offer based on at least one of
at least one prior outcome,
a number of plays,
an amount of coin in,
a wager amount,
a credit balance,
a rate of play,
an amount of losses,
a number losing outcomes,
a number pay lines selected, and
a time of a previous offer.

6. The method of claim 1, further comprising:
determining an alternate payout.

7. The method of claim 6, in which determining the alternate payout comprises:
determining a value of the alternate payout based on the credit balance.

8. The method of claim 7, in which determining the alternate payout based on the credit balance comprises:
determining an alternate payout based on a multiple of the credit balance.

9. The method of claim 7, in which determining the alternate payout based on the credit balance comprises:
determining an alternate payout based on a sum of the credit balance and a second amount.

10. The method of claim 6, in which determining the alternate payout comprises:
determining a value of the alternate payout based on a time since an event.

11. The method of claim 10, in which determining the value of the alternate payout based on the time since the event comprises:
determining the value of the alternate payout based on a monotonically non-decreasing function of the time since the event and the monotonically non-decreasing function is not a constant with respect to the time since the event,
thereby the function renders values of the alternate payout
which do not decrease with time, and
which increase over at least one predetermined period of time.

12. The method of claim 1, in which the step of outputting a cashless gaming ticket that represents the alternate payout comprises:
outputting a cashless gaming ticket that represents the alternate payout and that does not represent the credit balance.

13. The method of claim 1, in which the step of outputting a cashless gaming ticket that represents the alternate payout comprises:
outputting a cashless gaming ticket that represents
the alternate payout and
the credit balance.

14. The method of claim 1, further comprising:
providing a user interface before performing the step of outputting a cashless gaming ticket, in which the user interface is operable to receive at least one command from a player of the gaming device;
determining the alternate payout based on at least one command received via the user interface.

15. The method of claim 1, further comprising:
receiving a code; and
associating the code with the cashless gaming ticket.

16. The method of claim 1, further comprising:
printing an image of a player on the cashless gaming ticket.

17. The method of claim 16, further comprising:
capturing the image of a player using an image capture device which is positioned to capture images that are proximal to the gaming device.

18. The method of claim 1, further comprising:
determining a restriction on redemption of the cashless gaming ticket.

19. The method of claim 18, further comprising:
determining a restriction on a time when the cashless gaming ticket may be redeemed

20. The method of claim 1, in which outputting the cashless gaming ticket that represents the alternate payout comprises:
printing, on a paper substrate, indicia in accordance with the alternate payout.

21. An apparatus, comprising:
a processor; and
a memory in communication with the processor, in which the memory stores a program that, when executed by the processor, directs the processor to perform the method of claim 1.

22. An article of manufacture, comprising:
a computer-readable memory storing a program that, when executed by a processor, directs the processor to perform the method of claim 1
